(19) United States
(12) Patent Application Publication
(10) Pub. No.: US 2009/0287578 A1
(43) Pub. Date: Nov. 19, 2009

(54) CHARGING STATION FOR ELECTRIC AND PLUG-IN HYBRID VEHICLES

(76) Inventors: Michael Adam Paluszek, Princeton, NJ (US); Pradeep Bhatta, Plainsboro, NJ (US); Stephanie Thomas, West Windsor, NJ (US); Dave Wilson, Plainsboro, NJ (US)

Correspondence Address: FOX ROTHSCHILD LLP;PRINCETON PIKE CORPORATE CENTER, 2000 Market Street, Tenth Floor, Philadelphia, PA, 19103, US

(21) Appl. No.: 12/468,489

(22) Filed: May 19, 2009

Related U.S. Application Data
(60) Provisional application No. 61/054,194, filed on May 19, 2008.

(51) Int. Cl. G06Q 20/00

(52) U.S. Cl. 705/17

(57) ABSTRACT

This invention is a pay charging station for electric and plugin hybrid vehicles. A vehicle parks at a space with the charging station and uses a credit card, debit card, cash, smart card or network connection to a database like EZ-Pass to pay for the space and the electricity. The station automatically charges the vehicle as long as it is connected to the station. The station automatically stops charging when the vehicle is fully charged. The customer only pays for the space and the electricity consumed. If the charging circuit is broken the customer must reinsert the smart card or credit card to restart charging. Sufficient funds are removed from the payment method on initiation of charging. Any money not used for charging is returned to the funding account upon the user reinserting the smart card, credit card or debit card, or cash change is returned if cash was the method of payment.

### CROSS REFERENCE TO RELATED APPLICATIONS

This application is related to, and claims priority from, U.S. provisional application 61/054,194 filed on May 19, 2008 by Michael A. Paluszek and Pradeep Bhatta entitled “A PAY CHARGING STATION FOR ELECTRIC AND PLUG IN HYBRID VEHICLES”, the contents of which are hereby incorporated by reference.

### FIELD OF THE INVENTION

The present invention generally relates to charging of electric and plug-in hybrid vehicles, and particularly to a charging station for charging such vehicles.

### BACKGROUND OF THE INVENTION

Electric and plug-in hybrid vehicles are growing in number and will likely be the dominant form of road transportation within 50 years. A limitation of all electric vehicles is range as there are currently no convenient ways to recharge an electric or plug-in hybrid car. In the case of the latter vehicle it means that the vehicle must use gas thus increasing the operating cost per mile. Thus it is desirable for recharging stations to be established so that an electric or plug-in hybrid car can recharge at intermediate points in a trip. Recharging stations at locations where cars are commonly parked will also be beneficial.

There are two areas related to this invention. One is pay meters, such as those for parking. The other is recharge stations. Parking meters have existed for many years. At one time all meters required users to deposit coins. As the price of parking increased this became inconvenient. Two methods have been developed to solve this problem. One is the smart card meter. This meter uses a card with a digital computer and memory, containing information about the amount of money remaining in the card.

When a user inserts the card in a meter it deducts the desired amount to pay for the parking. A user can do this when they park. In a garage the user inserts the card into a kiosk on entry and then on departure to complete the transaction. This type of system is used in Princeton, N.J. An alternative is a credit card parking meter. These meters have been installed in Sacramento, Calif. A user inserts a credit card and charges the desired parking duration. This eliminates the need to carry another card or to refill a smart card but requires that the meter have a network connection to validate the card.

Recharging electric cars is a well-established technology. U.S. Pat. No. 4,158,802 issued Jun. 19, 1979 to Rose II describes the process. Tesla motors is establishing three charging stations for its Tesla electric roadster. U.S. Pat. No. 5,306,999 issued Jan. 15, 1993 to Hoffman describes a electric vehicle charging station mechanism incorporating linkages. U.S. Pat. No. 5,252,078 issued Feb. 23, 1993 to Langenbahn describes an electrical interconnection between a stationary fixture and a vehicle. The present invention improves on both recharging and pay meters. The improvement on pay meters is that it provides several ways to pay for the electricity. It can use cash, credit cards, smart cards, and online accounts which are accessed using EZ-Pass or a unique vehicle identification tied to the online account. This makes it much more convenient for the customer than any existing method.

### SUMMARY OF THE INVENTION

An aspect of the present invention provides a pay charging station for electric and plugin hybrid vehicles. A vehicle parks at a space with the charging station and uses a credit card, debit card, cash or smart card to pay for the space and the electricity. The station automatically charges the vehicle as long as it is connected to the station. The station automatically stops charging when the vehicle is fully charged. The customer only pays for the space and the electricity consumed. If the charging circuit is broken the customer must reinsert the smart card or credit card to restart charging. Sufficient funds are removed from the smart card on initiation of charging. Any money not used for charging is put back onto the smart card if the user reinserts it prior to leaving.

Another aspect of the present invention includes a pay charging station for electric and plugin hybrid vehicles, which includes a case for containing and protecting components of the charging station, a display for presenting status information to a user, a smart card reader and associated smart card input slot, a credit or debit card reader and associated credit or debit card input slot, a paper money collector and associated paper money input slot, a coin collector and associated coin input slot, the coin collector further connected to a button for the user to request return of change, and to a coin return chute, a keypad for the user to input information, the keypad being in communication with a computer processor and associated memory, the processor operatively in communication with the display, the smart card reader, the credit or debit card reader, the paper money collector, the coin collector, the button and the keypad, and a plug system for charging an electric or plugin hybrid vehicle. Typically, the processor and memory are configured to accept payment information from the smart card reader, the credit or debit card reader, the paper money collector, the coin collector, or the keypad and button. When necessary, the processor communicates via a communication interface with a network to authorize charges, and when payment has been made, provide charging power to the plug system for charging the electric or hybrid vehicle.

In other aspects of the invention, the pay charging station may allow for only some types of payment. For example, some embodiments may allow for only credit or debit card payment, or only smart card payment. Moreover, alternative payment mechanisms may also or alternatively be employed, such as payment over an Internet website wherein the user would key in a payment confirmation code, or wherein the vehicle itself would communicate a payment authorization code itself via a wired or wireless connection with the processor.

### BRIEF DESCRIPTION OF THE DRAWINGS

FIG. 1 is a diagram illustrating the pay station, in accordance with an embodiment of the present invention;

FIG. 2 is a diagram illustrating the network, in accordance with an embodiment of the present invention;

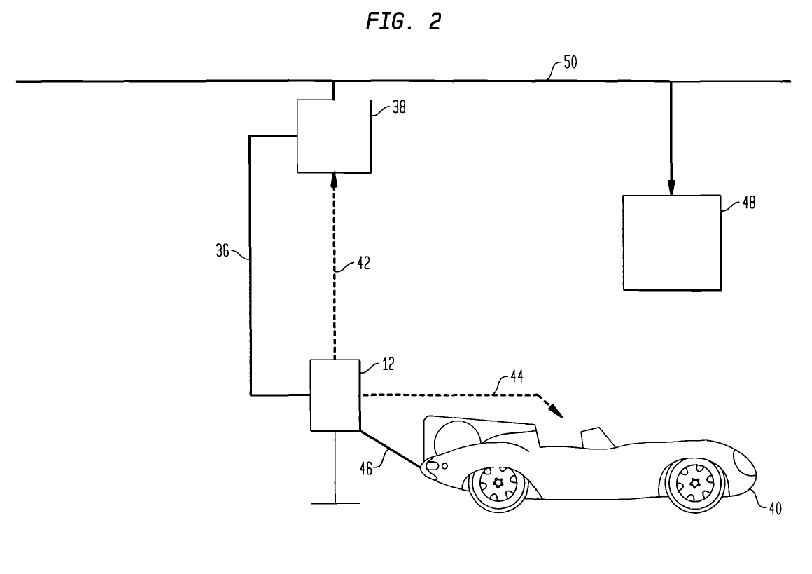

FIG. 3 is a first part of a flowchart showing system operation, in accordance with an embodiment of the present invention; and

FIG. 4 is a second part of a flowchart showing system operation; in accordance with an embodiment of the present invention.

### DETAILED DESCRIPTION

In the following description, for purposes of explanation, specific numbers, materials and configurations are set forth in order to provide a thorough understanding of the invention. It will be apparent, however, to one having ordinary skill in the art, that the invention may be practiced without these specific details. In some instances, well-known features may be omitted or simplified so as not to obscure the present invention. Furthermore, reference in the specification to “one embodiment” or “an embodiment” means that a particular feature, structure or characteristic described in connection with the embodiment is included in at least one embodiment of the invention. The appearances of the phrase “in an embodiment” in various places in the specification are not necessarily all referring to the same embodiment.

Although every reasonable attempt is made in the accompanying drawings to represent the various elements of the embodiments in relative scale, it is not always possible to do so with the limitations of two-dimensional paper. Accordingly, in order to properly represent the relationships of various features among each other in the depicted embodiments and to properly demonstrate the invention in a reasonably simplified fashion, it is necessary at times to deviate from absolute scale in the attached drawings. However, one of ordinary skill in the art would fully appreciate and acknowledge any such scale deviations as not limiting the enablement of the disclosed embodiments.

The present invention advantageously provides for a charging station for electric and plugin hybrid vehicles which allows any or all of an assortment of payment types.

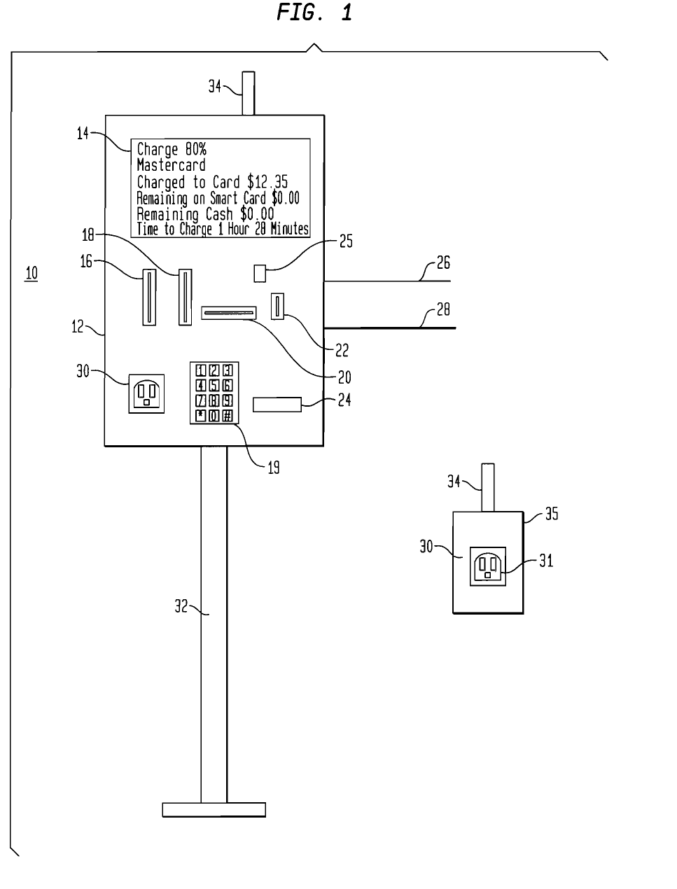

An embodiment of the invention is shown in FIG. 1.

A case, 12, holds all of the electronics and mechanisms of the charging station 10. The case is hardened to prevent vandalism and to prevent theft of stored cash. It is also weatherproofed for use outdoors. Case hardening is a well-established technology as shown by U.S. Pat. No. 4,857,119, issued on Mar. 1, 2008 to Karst.

The user views a display 14 that presents status information to the user. It tells the user what kind of credit card has been inserted. The display may display alphanumeric, graphical information or a combination of both. If the user has an online account it tells them the amount of money stored in the account. If they are using a smart card with money stored on the card it tells them how much money is left. If they are using cash it tells them how much cash they have entered. It also displays the state of charge of the vehicle and the expected time to charge fully. Other status information can also be displayed.

Users may employ smart cards, credit cards, cash, or combinations thereof. In an embodiment of the invention, a smart card slot 16 is also provided. If the user inserts a smart card into the smart card slot 16, the charge station will attempt to use that card. When using a smart card the station will deduct enough money to fully charge the vehicle. After charging the user may reinsert the card to be credited for any unused funds. If the smart card is for an online account, the station charges up to the amount remaining in the online account. The online account can be replenished by electronic funds transfer or credit card.

Users who choose to use a credit card will insert it in the credit/debit card slot 18. When a credit card is entered and withdrawn the station checks the validity of the card. It is possible for an embodiment to use a single slot in place of both the smart card slot 16 and the credit/debit card slot 18. An example of such a device is the IDTECH SPT3-8xx and SPT3-5xx series Hybrid mag stripe and smart card reader.

A keypad 19 for entering information is also provided. It is used for entering debit card Personal Identity Number (PIN)s and for entering a password for getting change back when the user returns to the car after charging is complete. At that time the user enters the password and change is returned.

Cash may be inserted using paper money slot 20. As bills are entered they are scanned and the stored amount incremented. Bill acceptors are well known technology and many bill acceptors are commercially available. An example is the Coinco BillPro. Coins are input using coin slot 22. As coins are entered the amount stored is incremented. Change is returned via change return slot 24 after charging. Change is returned when charging is stopped or by pushing the return change button 25. Hitting this button stops charging if it has started and returns any unused funds.

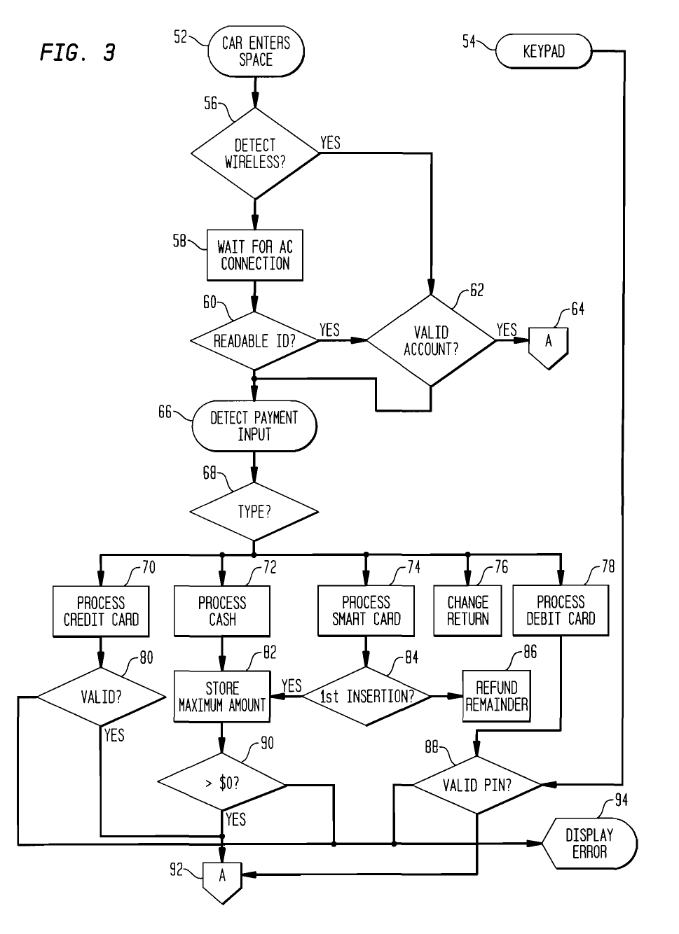

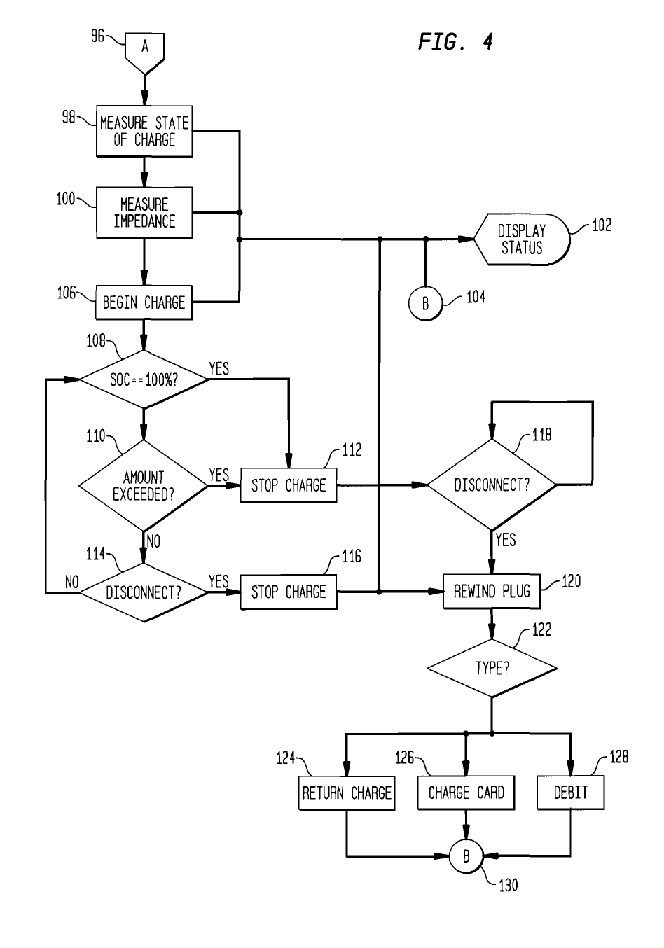

The various input slots 16, 18, 20, 22, 24 keypad 19, display 14 and coin return button 25 are each in operational communication with a computer processor and associated memory (neither depicted). The computer processor and mamory are configured with software for accepting input from and directing the actions of these various components in fulfillment of the operating processes necessary to enable the described functioning of the present invention, for example, as this functioning is described in FIGS. 3 and 4 herein. In an embodiment of the invention, the processor and associated memory may be in further communication with external systems or databases, potentially, but not exclusively via an Internet website.

Communications with the processor may be wireless or wired. A wired communications line 26 for Ethernet which connects the station to a local area network is optionally employed. The network is used for testing the station and for communicating online accounts and credit card charges. It can be used interchangeably with 34. Wireless technology is well established. Bluetooth (IEEE 802.15.1), WiFi (IEEE 802.11a,b,g,n) and ZigBee (IEEE 802.15.4) are possible candidates.

Power is provided via the power line 28 at the appropriate frequency, voltage and current. The power input can be configured to accept a range of voltages (110 to 220 V) and frequencies (50 to 60 Hz.)

In an embodiment of the invention, the connector to the car is through a flexible cable 30, such as in a plug, cable and retraction system. The plug is retracted when released from the vehicle. The retractor may be powered or a simple tension reel. The power delivery cable is protected by a ground fault circuit interrupter 31 (GFCI). The GFCI may be monitored and reset by a central pay station. Ground fault circuit interrupter technology is well-established. For example, see U.S. Pat. No. 6,930,574 issued on Aug. 16, 2005 to Gao, which describes one type of GFCI system.

The box may be mounted on a pedestal 32. The system may also be wall mounted. Other mounting options are possible and would depend on the location and layout of the installation location.

Communication with the satellites and a central station can be via is a wireless communications line 34 for Ethernet, which connects the station to a local area network. The network is used for testing the station and for communicating online accounts and credit card charges. It can be used interchangeably with a wired connection 26.

The central Kiosk can control satellite stations that deliver the power to the automobile. An exemplary wireless satellite power connection 35 is also depicted in FIG. 1. The satellite connector consists of a current sensor, relay, processor and wireless hardware. It is controlled by the Kiosk. Any number of satellite power connectors may be used. If more than one Kiosk is used, then a given wireless connector may be controlled by any Kiosk.

The Kiosk uses an Internet modem 38 to connect to the Internet. The vehicle 40 may be an electric or plugin hybrid vehicle.

A wireless connection 42 to the Internet router can replace the wired connection in an embodiment of the invention.

A wireless connection 44 can be provided between the vehicle and the pay charging station. This connection 44 may be to a wireless node on the vehicle or a device such as an EZ-Pass box. EZ-Pass is a technology used in the northeast United States for automobile tolls. It consists of an RF device in a car that responds to an external RF signal. The box in the automobile does not require any other power.

The AC connection 46 also carry communications signals between the Kiosk and the automobile. The AC connection 46 may also be the signal path for the data from the vehicle. Power line communication or power line carrier (PLC), also known as Power line Digital Subscriber Line (PDSL), mains communication, power line telecom (PLT), or power line networking (PLN), is a system for carrying data on a conductor also used for electric power transmission. The technology is commercially available from numerous vendors. For example, power line communication is enabled by power line modems such as the Texas Instruments TMS320F2808.

An online account server 48 may be used to process the payments. For example, the online account server 48 may be on the Internet. It also may represent credit card servers and EZ-Pass servers.

FIG. 3 and FIG. 4 show the operation of the system in an embodiment of the present invention. The operation is shown in the flow chart.

A car enters a space served by the charger in Block 52. The charger antenna has a narrow focus or field-of-view, so it only sees the space. It also only locks onto vehicles that are not moving. If it does not detect wireless, which can be either an EZ-Pass or wireless transmitter in the vehicle, it does nothing. The keypad is used to enter PIN numbers or any other alphanumeric user inputs in Block 54.

If wireless is detected the charger connects to the Internet and looks for a valid account in Block 56. This can be an online account for recharger or EZ-Pass. If a valid account is found, control passes to Block 64.

If no wireless signal is detected, the charger waits for an AC connection in Block 58. This happens when the user plugs in their car. In Block 60 the charger attempts to read an identification number through the AC connection. The car sends the identification number through the AC connection. The identification number is modulated onto the AC and a filter on the charger side demodulates the signal. If an identification number is found it goes to Block 62 and repeats the same process described above. If the account is valid it control passes to to Block 64, which checks for a valid account and transfers to the charging block.

If no online account is found then the charger waits for a payment form in Block 66. It automatically detects the form of the payment when a credit card, cash, smart card or debit card is entered. The charger identifies the type of payment in Block 68 and processes a credit card in Block 70.

Cash is processed in Block 72 by reading in the denominations of bills or coins entered. As soon as any cash is entered it starts the charging process. The total entered is accumulated in memory. When cash is used the user can enter a PIN. This PIN needs to be entered to get change back.

Smart cards are processed in Block 74 by reading the memory cell on the card. Change is returned in Block 76 when the change return button is the selected input.

A debit card is processed in Block 78. This block passes to Block 88 which checks for a valid PIN.

The validity of the credit card is determined in Block 80. The maximum amount of money available for charging is stored in Block 82. Block 84 checks to see if this is the first insertion of the smart card. If it is the 1st insertion it transfers the entire balance to the charging account. If it is the 2nd insertion it passes to Block 86. Block 86 refunds unused money to the smart card. Block 88 checks for a valid debit card PIN. Block 90 checks to see if the available amount is greater than $0. Block 92 transfers to the charging flowchart. Block 94 displays all error messages to the display. Block 96 is the transfer point from the payment processing flowchart. Block 98 measures the state of the charge. This may be provided through the wireless connection or through the AC circuit data communications. It can also be measured by the charging station. Block 100 measures the connection impedance. This and the state of charge are used to verify that if a disconnect occurs the same car is then reconnected. Block 102 displays the status of the charging process to the display. Several blocks send their output to this display block. Block 104 is the transfer point from the payment final processing blocks.

The charge process begins at Block 106. This is just closing the AC circuit. Block 108 checks to see if the car is fully charged. Block 110 checks to see if the stored amount is exceeded. Block 112 stops the charging by opening the charging circuit. Block 114 checks to see if the car is disconnected. Block 116 stops the charging by opening the charging circuit. Block 118 checks for a disconnect. Block 120 rewinds the cable automatically by turning on the rewind motor. Block 122 selects the next block based on the type of payment from information obtained earlier. Block 124 returns change if cash was used. This is done when the same PIN is entered that was entered when cash is used. Block 126 charges the credit card. Block 128 debits the debit card and Block 130 sends the payment information to the display.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A pay charging station for electric and plugin hybrid vehicles, the charging station comprising:
a case for containing and protecting components of the charging station;
a display for presenting status information to a user;
a smart card reader and associated smart card input slot;
a credit or debit card reader and associated credit or debit card input slot;
a paper money collector and associated paper money input slot;
a coin collector and associated coin input slot, the coin collector further connected to a button for the user to request return of change, and to a coin return chute;
a keypad for the user to input information, the keypad being in communication with a computer processor and associated memory, the processor operatively in communication with the display, the smart card reader, the credit or debit card reader, the paper money collector, the coin collector, the button and the keypad; and
a plug system for charging an electric or plugin hybrid vehicle;
wherein the processor and memory are configured to
accept payment information from the smart card reader, the credit or debit card reader, the paper money collector, the coin collector, or the keypad and button,
when necessary, communicate via a communication interface with a network to authorize charges; and
when payment has been made, provide charging power to the plug system for charging the electric or hybrid vehicle.

2. The pay charging station according to claim 1, in which the station can provide charging power for a different vehicle using the station without inserting a new payment means.

3. The pay charging station according to claim 1, wherein the communications interface uses wireless connectivity.

4. The pay charging station according to claim 1, further comprising the processor communicating with one or more payment databases.

5. The pay charging station according to claim 1, wherein the user can input online account information for payment.

6. The pay charging station according to claim 1, wherein the processor can communicate with a vehicle via the charging plug system.

7. The pay charging station according to claim 1, wherein the processor communicates with a vehicle through a wireless connection.

8. The pay charging station according to claim 1, wherein the processor is further configured to return deposited cash when the user inputs a valid personal identification number (PIN).

9. The pay charging station according to claim 1, wherein a smart card with a built-in computer processor can be used for payment.

10. The pay charging station according to claim 1, that can utilize a credit or debit card for payment.

11. The pay charging station according to claim 1, further comprising an EZ-Pass reader in communication with the processor, wherein an EZ-Pass account is used for payment.

12. The pay charging station according to claim 1, in which multiple wireless power connectors are controlled by the processor.

13. The pay charging station according to claim 1, in which multiple wired power connectors are controlled by the processor.
